(19) United States
(12) Patent Application Publication
(10) Pub. No.: US 2002/0117168 A1
(43) Pub. Date: Aug. 29, 2002

(54) Elimination of fatty acid deposits from ethylated starch solutions

(76) Inventor: James J. Foster, Clinton, IA (US)

Correspondence Address: Michael E. Yates, Archer-Daniels-Midland Company, 4666 East Faries Parkway, Decatur, IL, 62526, US

(21) Appl. No.: 09/860,747

(22) Filed: May 18, 2001

Related U.S. Application Data
(60) Provisional application No. 60/271,287, filed on Feb. 23, 2001.

(51) Int. Cl. C08B 30/00

(52) U.S. Cl. 127/71

(57) ABSTRACT

Processes for the elimination of deposit formation during starch processing are provided. The processes include one or more of raising the pH of ethylated starch solutions to a pH above 7; adding uncooked oxidized starch to cooked ethylated starch; adjusting the conductivity of uncooked ethylated starch granules; and/or silicone treatment of vessel surfaces.

This application claims priority to Provisional Application Serial No. 60/271,287, filed on Feb. 23, 2001.

### FIELD OF THE INVENTION

The invention relates to starch processing, and more specifically to processes for the elimination of deposit formation during starch processing.

### BACKGROUND OF THE INVENTION

Starch is a naturally occurring polymer made up of simple sugars, and is generally obtained by processing plant materials. The plant materials from which starch is derived include, for example, corn, wheat, potato, and tapioca. Of these plant materials, corn is one of the most widely used plant sources for starch in North America.

Starch has a number of unique properties that makes it suitable for a variety of applications. One of starch's many properties is its ability to form a viscous fluid upon application of energy and water. Energy can be in the form of either thermal or mechanical energy. This process is typically referred to as cooking or pasting the starch, but other terms are sometimes used in the art. The viscous fluid is typically called “paste” in the starch industry, and can be applied to substrates such as paper and textiles whereby it, among other things, increases the stiffness of the material, and affects the absorbativity of the paper.

Another property of starch is that uncooked starch granules are relatively free flowing and can be dried for extended storage and/or easy transport to the location where the starch is to be used. Broken or damaged granules, however, are not free flowing and can clog various filtering devices used in uncooked starch processing. For this reason, processing to liberate the starch from the plant source is performed under conditions which minimize the disruption of the starch granules.

Obtaining the starch granules from plant sources requires separating the starch granules from the non-starch components such as protein, oils, hulls, skin, germ, fatty acids, etc. The separation process is not 100% effective, and therefore, a small amount of non-starch material is retained in the starch. Additionally, because it is derived from natural sources, there is an inherent variation in the concentration of starch granules and non-starch components in the source plant material. These variations can be attributed to factors such as the particular species of plant, the growing conditions, the soil, etc.

Typically, when designing a starch separation process, a manufacturer will use a representative value for the non-starch components. However, because the concentration of the various components in the source plant material will have variations, the final starch will also have small variations in the unwanted non-starch components. While it would be possible to design a system to account for the natural variations in feed material an thereby eliminate almost all non-starch components, an appreciable amount of starch would be lost with the non-starch components. Furthermore, these non-starch components can be of less or greater value than the starch. Thus, the design of a starch separation system is a balance between separating as much of the non-starch components while retaining as much of the starch as feasible.

While starch has a number of unique properties, it has some properties that can limit its use in certain applications. For example, cooked starch has a tendency to congeal and fall out of solution if the paste hold temperature drops below a certain level. This tendency to drop out of solution is called “retrogradation.” Once a starch retrogrades, it is difficult to get the cooked starch back in solution.

Another property that limits the use of cooked starch is the tendency to form amylose crystals under certain pH and temperature conditions. Amylose is a type of starch that is essentially a straight chain of simple sugars. (The other major type of starch is amylopectin, which is a branched molecule.) Amylose crystals are undesirable because, among other reasons, they have a limited ability to bind to substrates and subsequently be removed in such processes as print, for example. A cooked starch paste has a greater tendency to form amylose crystals under low pH conditions (7.5 pH or less) and at temperatures between 153 and 193° F. (Wurzburg, O.B., Modified Starches: Properties and Uses, CRC Press, Inc., Boca Raton, Fla., 1986, pg. 226).

To expand the use of cooked starch applications, manufacturers can chemically alter, or “modify,” the starch molecule. To preclude the retrogradation or amylose formation, the starch is modified so as to cause bulky chemical groups to form on the side of the starch molecule. The bulky side groups keep adjacent starch molecules from getting in close proximity, and thus hinder the tendency to coalesce. In addition, the bulky side groups also reduce the tendency to form amylose crystals.

The modification of starch can be performed on either cooked or uncooked starch. There are, however, certain advantages to performing the modification on the uncooked granules, such as ease of storage, handling, etc. For uncooked granules, the starch modification is accomplished by treating an aqueous starch suspension with a reagent. Depending on the product being formed, the modification can be accomplished by treating with reagents including, but not limited to, ethylene oxide, hydrochloric acid, and sodium hypochlorite. While it is important to note that all of the starch reactions discussed herein are performed on uncooked starch granules, because of the ease in handling the starch in a manufacturing setting. It is equally important to point out that it is the resultant properties of cooked starch from these granules that is desired.

One common technique used by industry to add bulky side groups to starch molecules (or chains) is to add carboxylic groups. This is accomplished by reacting starch with an oxidant. These oxidants include, but are not limited to, sodium hypochlorite, calcium hypochlorite, etc. In addition to adding bulky side groups, the oxidation reaction causes changes such as reducing the viscosity of the cooked starch paste by “clipping” the length of the starch molecule. When either sodium or calcium hypochlorite is used as an oxidant, the reaction is run under alkaline conditions, which maximizes the production of carbonyl and carboxylic acid side groups (Wurzburg, pp. 23 to 29). At the end of the reaction, the excess alkalinity is neutralized with acid.

In a similar fashion, ether moieties can be attached to the starch to reduce the tendency to form amylose crystals. Typically, these ether moieties are hydroxyethyl or hydroxypropyl groups, but other groups can be used. For example, hydroxyethyl addition can be used, however, a person skilled in the art can apply these techniques to other esterifications. The addition of hydroxyethyl ether to starch is accomplished by reacting starch with ethylene oxide under alkaline conditions. Since alkaline conditions can cause the starch granules to swell, sodium chloride, sodium sulfate, or equivalent non-reacting salts are added to the mix to decrease the osmotic pressure on the granule, thereby reducing the chance it will swell and rupture. Lowering the pH of solution to below 7 terminates the ethylation reaction. Starch manufactured in this process is called either hydroxyethyl starch or simply ethylated starch. If a lower viscosity starch is needed, the ethylated starch is treated with an acid until the proper viscosity is obtained.

After modification, the starch granules are pressed and then dried using flash dryers, belt dryers or other such devices suitable to reduce the moisture content. The pressing process removes the excess water, reducing the amount of drying that needs to be performed.

In many cases, the starch granules are washed to remove some of the salt used in the ethylene oxide reaction. This is usually performed immediately after pressing while the starch slurry is still in the press. Water is introduced into the press and allowed to flow over the starch granules until the proper amount of washing is obtained. In many instances, the residual chloride level in the starch determines the amount of washing.

There are many reasons why it is desirable to reduce the salt concentration in starch. One reason is to reduce the conductivity of paper made with a surface treatment of ethylated starch. Such papers low in conductivity could be used in the electronics industry. Another reason is that aqueous solutions containing chloride ion (from sodium chloride used in the ethylation process) can be corrosive to metals. Thus many starch users want an ethylated starch with a low chloride concentration.

The chloride level in dry starch is determined by taking 30 grams of starch and adding de-ionized water until the total weight of starch and water is 100 grams. The chloride level is then measured using standard techniques known to those skilled in the art.

Determining the chloride level in a starch sample is an involved chemical process. Therefore, starch manufacturers and users may elect to use a conductivity test as a surrogate for the chloride determination. The conductivity test would use the same starch to water ratio as the chloride test and is a measurement of how much electricity can pass through the solution.

Under certain conditions, the naturally occurring non-starch components in the cooked starch solution can deposit on processing equipment, thereby causing operational problems such as clogged filters, reduced flow rates, etc. These operational problems can be so severe as to cause the equipment to be shut down for cleaning, which can cost tens of thousands of dollars per hour.

Analysis of such deposits have found that it is typically composed primarily of calcium salts of fatty acids, free fatty acids, and a small amount of protein. In starch, the typical concentration for soluble fats is about 0.7%, and the soluble fats include fatty acids. In corn oil, fatty acids usually include such compounds as palmitic acid, stearic acid, oleic acid, linoleic acid, etc. In aqueous solutions, these fatty acids can react with calcium ions to form calcium palmate, calcium stearate, etc. that deposit on the sides of the container. These deposits of calcium salts of the fatty acids are sometimes called “soap scum.” Also, a portion of the free fatty acids will also deposit on the walls and float on the top of the vessel along with the calcium salts of the fatty acids.

Experts in the industry for have tried to solve this problem for some time without reaching a cost-effective solution. One way to reduce the rate of deposit formation is by increasing the cooked starch solution temperature above the melting point of the fatty acids. This helps by keeping the fatty acid in a liquid state and allows it to be carried along with the starch solution. However, while this method can reduce the deposition of the fatty acids/calcium fatty acids, it has several disadvantages, including higher energy cost to keep the system at the elevated temperature, and the potential for the fatty acids to deposit on a “cold” spot in the pipes, tanks, equipment, etc. Additionally, it only reduces the problem, it does not eliminate it.

Alternatively, the deposits may be eliminated by reducing the concentration of calcium ions in the system. This can be done by treating the water with an ion exchange resin, or by adding a sequestering agent like ethylenediaminetetraacetic acid (EDTA) or citric acid. The resin and sequestering agent bind with the calcium ion preventing it from complexing with the fatty acids. Regarding the practicality of this approach, EDTA and citric acid are relatively expensive chemicals and the ion exchange system has high initial costs and subsequent regeneration costs. Therefore, if only a small amount of water is to be treated then either of these treatments might be cost acceptable. However, if a great amount of water needs to be treated, then these methods are usually cost prohibitive.

While one can reduce the concentration of calcium ion in a cost effective manner, it is somewhat impractical to greatly affect the concentration of fatty acids in the system. The reason is that some of the fatty acids are entrained within the starch granule, therefore, they cannot be easily removed by processing.

### SUMMARY OF THE INVENTION

The inventor has determined that fatty acid deposits in ethylated starch solution can be significantly reduced by a number of different processes. These processes can be performed individually, or some or all of them can be performed at the same time. The processes are:

Raise the pH of the system to above 7 units.

Add a small amount of oxidized starch to the ethylated starch.

Ensure the conductivity is greater than 2.0 mMHO.

Treat the vessels with a material that will change the charge on the surface, such as applying silicone.

While performing these actions together will result in a synergistic effect on reducing the deposit, all these actions need not be performed. Indeed, some starch users need not go to the expense of doing all these processes if one or two is sufficient to alleviate the problem.

### DETAILED DESCRIPTION OF THE INVENTION

Each of the ways to reduce the fatty acid deposit in ethylated starch solutions will be discussed separately below.

Adjusting the pH

In many starch systems, the pH of the cooked starch is closely monitored to keep it out of the critical range for amylose crystal formation (less than 7.5 pH). However, in the case of ethylated starch, little pH control is needed since amylose crystals rarely form with this product. Thus, many ethylated starch users will allow the pH to drift over a wide range with typical ranges seen in the industry between 6-7 pH units. (The pH of ethylated starch tends to be on the acidic side due to the acid treatment during the viscosity modification process.)

While the pH in the 6-7 range has minimal affect on the properties or amylose formation of ethylated starch solutions, this pH will have a significant effect on fatty acid deposits. Below a pH of 7, the fatty acids will be in the “free” form or

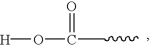

Where “ [symbol] ” is a hydrocarbon chain. Free fatty acids with 12 carbon chains and higher are not very soluble in water and therefore tend to deposit on the sides of vessels. (“vessels” meaning any type of container for the starch, including, but not limited to tanks, pipes, screens, process equipment, etc.)

Raising the pH of the solution to above 7 units will cause a hydrogen ion to be removed from the acidic group thereby forming the ionized fatty acid or

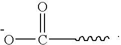

This form of fatty acid is more soluble in water. Therefore, one can reduce the tendency to form the fatty acid deposit in cooked ethylated starch by adjusting the pH to over 7 units. The pH can be adjusted well above 7, although those of skill in the art will recognize that too high a pH may cause the starch to discolor. A pH from 7 to about 9 is preferred.

Oxidized Starch

As mentioned in the background section, oxidation of starch causes the formation of carboxyl and carboxylic acid groups on the side of the starch molecule. These bulky side groups reduce the tendency of the amylose molecules to coalesce into crystals in cooked starch solutions.

It is interesting to note that the cooked oxidized starch solutions do not form a fatty acid deposit like cooked ethylated starch. This lack of deposit is attributed to the higher pH used (7 units and above) in the cooked oxidized starch systems and the carboxylic acid will lose a hydrogen ion to form:

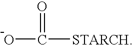

This carboxylic acid group on starch can react with calcium ion in a similar way that fatty acids do when they form soap scum. In essence, these carboxylic acid groups become an inexpensive sequestering agent for the calcium ion in the same fashion that EDTA or citric acid is used. Thus the reason that the fatty acid deposit is not seen when using oxidized starch is attributed to a portion of the calcium ion binding to the acid groups, thereby lowering the amount available to react with fatty acids.

While some starch users are able to switch from an ethylated to an oxidized starch, there are some disadvantages to using oxidized starch. The primary one is that oxidized starch requires more monitoring because of the potential for amylose formation, retrogradation, etc. than does ethylated. Furthermore, ethylated starch is a better film former than oxidized starch thus has better coating properties.

In order to maximize the advantages of each product, i.e., no deposit formation with the oxidized starch and easier handling and film forming with the ethylated, one can either modify a starch molecule so it will contain both ethylated and carboxylic acid groups or produce a blend containing oxidized starch and ethylated starch. Of the two methods, the preferred embodiment would be the mixing of the two starches since the amount of carboxylic acid groups required for the calcium ion would be relatively minor. Indeed, the amount of oxidized starch would only need to be≦10% of the ethylated starch used in the produce in order to complex with the calcium ion.

Note that while it is known that oxidized starch will complex with calcium ion, it has not been previously known that an oxidized starch may be mixed with an ethylated starch to make a product which has the advantages outlined above. Floor, M. et al. “Preparation and Calcium Complexation of Oxidized Polysaccharides,” Starch/Stärke 41 (1989) Nr. 9, S. 328-354.

Decreasing Washing of Uncooked Starch

Another novel and unexpected portion of the invention is that decreasing the washing of the ethylated starch will help eliminate the fatty acid deposit. Indeed, intuitively one would believe than an increase in washing will reduce the concentration of a contaminant in a product.

The present inventor has discovered that too much washing of ethylated starch will contribute to the formation of fatty acid deposits on vessels containing cooked starch. For example, an unwashed ethylated starch will have a conductivity of 6 mMHO or higher, while a highly washed product will have a conductivity of less than 1.1 mMHO. At this high level of washing, fatty acid salts will have the tendency to deposit in the system.

The relationship between washing ethylated starch and fatty acid deposits is attributed to the electrolyte concentration in the system. These electrolytes such as sodium ion, chloride ion, sulfate ion, etc. are believed to absorb onto the walls of the vessel thereby removing potential binding sites for the fatty acid complex. Since the fatty acid complex can't attach to the vessel, it is carried through with the starch solution. A more thorough discussion can be found in the literature. Rosen, M. J., Surfactants and Interfacial Phenomena-2^{nd} Edition, pg. 56, John Wiley & Sons, New York, (1989); Myers, D., Surfactant Science and Technology-2^{nd} Edition, pg. 284, VCH Publishers, Inc., New York, (1992).

For the purposes of reducing the fatty acid complex deposit the conductivity should be above 1.4 mMHO and preferably above 2.0 mMHO. Please note that the conductivity can be obtained by either reduced washing of the starch or by adding a suitable salt such as, but not limited to, sodium chloride, sodium sulfate, etc. to the starch. Either treatment should give comparable results.

Treating Vessels

From the above discussion, it is apparent that the surface of the vessel plays an important role in the deposition of the fatty acid complexes. The surface has to be suitable to be “bound” to the fatty acid deposit. This “bond” is attributed to an induced charge on the surface that allows the calcium ion to bridge between the surface and the fatty acid.

In the foregoing processes, the invention dealt with treatment of the ethylated starch to eliminate the deposit. Since the surface plays a role in the deposit, one can also reduce the formation of it by treating the vessel itself.

From observations of the equipment, the deposit is seen primarily on metal surfaces, but to a lesser extent on plastics. In general, plastics tend to be non-polar, hydrophobic materials, while metals will have an ability to have a charge associated with the surface. One can change the characteristic of the material surface by applying a suitable coating. For example, a silicone treatment of the vessels will affect the wettability and the number of potential binding sites for the deposit. By changing the potential binding sites, the affinity of the deposit for the vessel walls is reduced and subsequently the deposit is carried along with the starch solution. In the invention, the vessel is treated with silicone so to change the surface charge and thereby decrease the deposit.

Once given the above disclosure, many other features, modifications or improvements will become apparent to the skilled artisan. Such features, modifications or improvements are therefore considered to be part of this invention, the scope of which is to be determined by the following claims.

What is claimed is:

1. A process for the reducing the deposit caused by a fatty acid complex when using cooked ethylated starch solutions, the process comprising:
adjusting the pH of the said ethylated starch solution to above 7 pH units.

2. A process for the reducing the deposit caused by a fatty acid complex when using cooked ethylated starch solutions, the process comprising:
adding up to 10% (wt) uncooked oxidized starch to the uncooked ethylated starch prior to cooking.

3. A process for the reducing the deposit caused by a fatty acid complex when using cooked ethylated starch solutions, the process comprising:
adding up to 10% (wt) cooked oxidized starch to the cooked ethylated starch.

4. A process for the reducing the deposit caused by a fatty acid complex when using cooked ethylated starch solutions, the process comprising:
treating the uncooked ethylated starch granules so that the conductivity is at 1.4 mMHO or above.

5. A process for the reducing the deposit caused by a fatty acid complex when using cooked ethylated starch solutions, the process comprising:
silicone treatment of surfaces contacted by said cooked ethylated starch solution.
